(19) United States
(12) Patent Application Publication
(10) Pub. No.: US 2010/0131729 A1
(43) Pub. Date: May 27, 2010

(54) INTEGRATED CIRCUIT WITH IMPROVED DEVICE SECURITY

(75) Inventors: Patrick Fulcheri, Antibes (FR); Harald Bauer, Nuernberg (DE); Jean-Philippe Perrin, Seoul (KR)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/722,520

(22) PCT Filed: Dec. 19, 2005
(86) PCT No.: PCT/IB05/54314

§ 371 Date: Feb. 3, 2010

(30) Foreign Application Priority Data
Dec. 21, 2004 (EP) 04300929.9

(51) Int. Cl. G06F 12/14; G06F 12/00

(52) U.S. Cl. 711/163; 711/E12.001; 711/E12.093

(57) ABSTRACT

A semiconductor device having circuitry comprising an embedded memory, an embedded processor for executing application codes, and a functional hardware element coupled with the embedded memory via a protected bus, and with the embedded processor via an unprotected bus, the hardware element being arranged to protect the protected bus, and including a locking means comprising at least one lock bit for globally locking at least part of the locking means before executing the application code.

This invention relates to a functional hardware element embedded within a semiconductor device for protecting the device from unauthorized access.

Modern semiconductor devices, for example, integrated circuits, include a large number of functions and it is necessary, especially in circuits for data-processing, to protect certain device functions from unauthorized access. This is because all functions, the circuit, and the bus that carries information are internal to the device. Access to memories or other peripheral devices attached to the semiconductor device is normally routed through a security apparatus to provide protection in the form of keys.

For example, US2002/0059518 A1 discloses a method and apparatus for ensuring secure, controlled access to a plurality of functions in an electronic system, each of these functions having a corresponding key associated therewith. The method comprises the steps of selecting a key corresponding to a desired function, conducting an authentication process which includes verifying the selected key, and allowing or denying access to the desired function in accordance with the result of the authentication process.

Furthermore, different functions such as encryption and decryption routines, codes in mobile phones for achieving specific features, etc. may have different access policies. In many devices with embedded processors, a program code or information data in the embedded memory can be read by any application running on the embedded processor such as a JAVA program. The embedded memory may contain critical information that must be protected from unwanted access.

The use of keys has the disadvantage that they can be hacked by a malicious code. Consequently, external devices that are not supposed to have such access could gain access to protected functions, thus compromising device security.

It is an object of the present invention to improve device security.

According to the invention, this object is achieved by means of a semiconductor device as defined in the independent claim 1.

The semiconductor device has circuitry comprising an embedded memory, an embedded processor for executing application codes, and a functional hardware element coupled with the embedded memory via a protected bus, and with the embedded processor via an unprotected bus, the hardware element being arranged to protect the protected bus, and including a locking means comprising at least one lock bit for globally locking at least part of the locking means before executing the application code.

In a further embodiment, the locking means is arranged to protect areas of the embedded memory.

The functional hardware element performs the role of a firewall by restricting unauthorized access to the protected bus, and hence can preferably restrict access to areas of the embedded memory that need to be protected. In this case, the functional hardware element prevents unauthorized access by locking such areas of the embedded memory, preferably using the locking means. The locking means can itself be locked by an additional lock bit before any application code on the embedded processor is initialized. At least one lock bit is arranged to globally lock at least a part of the locking means, which in effect freezes the state of at least part of the locking means. Once locked, the state of the lock bit cannot be altered as long as there is any code running on the embedded processor. Program codes running on the processor therefore cannot change the state of the locking means. Because of the protection provided to the protected bus, for devices connected to the protected bus such as the embedded memory, any device on the unprotected bus trying to gain access to such a device cannot affect it. In particular, a malicious code running on the embedded processor cannot directly access the locked areas of the embedded memory.

In a further embodiment, the locking means comprises lock registers, and at least one lock bit is arranged to globally lock at least part of the lock registers.

In another embodiment, the functional hardware element includes a configuration means comprising configuration registers for storing access for the protected bus, conditions and a lock register which is associated with at least one of the configuration registers for selectively allowing or denying access to said at least one of the configuration registers.

The locking means preferably comprises at least one lock register. At least one lock bit is arranged to globally lock at least a part of the lock registers such that these registers are no longer available from the unprotected bus. The configuration means preferably comprises sets of configuration registers that can be used to define the protection level for devices on the protected bus and in particular areas of the embedded memory. Conditions for allowing or denying access to the protected bus, in particular devices on the protected bus, are stored in the configuration registers. A lock register is preferably associated with one or more configuration registers and selectively allows or denies access to its associated configuration register from devices on the unprotected bus, such as the embedded processor running application code.

In a further embodiment, an activated lock register indicates that the associated at least one of the configuration registers is arranged to read only, and an inactivated lock register indicates that the associated at least one of the configuration registers is arranged to both read and write.

The lock registers preferably set the protection for the configuration registers depending on activation or deactivation of the lock register. Depending on the state of the lock register, access to the corresponding configuration register can therefore be either allowed or denied. Preferably, when a lock register is not activated, the corresponding configuration register can be either read from or written to by devices on the unprotected bus, and when the lock register is activated, the corresponding configuration registers can only be read from the unprotected bus.

In yet another embodiment, the configuration registers are arranged to define a protected embedded memory area.

The configuration registers preferably define a protected area of the embedded memory, for example, by storing the start address and the end address of the embedded memory.

Another embodiment comprising the hardware firewall is characterized in that, after setting the lock bit, an unlocked part of the locking means is still accessible from the unprotected bus.

As discussed hereinbefore, the lock bit is preferably arranged to globally lock at least a part of the lock registers such that these registers are unavailable to any malicious code trying to gain access to the protected bus and in particular to protected parts of the embedded memory. Devices on the protected bus and the embedded memory that were not protected at the time of setting the lock bit are still available to devices on the unprotected bus seeking access.

In a preferred embodiment, the functional hardware element includes a conditional checking means coupled with the configuration means for comparing a request for access to the protected bus with the access conditions stored in the configuration means, and providing a signal to the locking means for allowing or denying said request for access in dependence upon the result of said comparison.

A conditional checking means is coupled to the configuration means. It compares a request for access to the protected bus with the access conditions programmed and stored in the configuration means. The conditional checking means generally continuously examines the unprotected bus for any access requests. After detecting an access request, a comparison is made and the conditional checking means can then provide the locking means with a relevant signal for allowing or denying a request for access to the protected bus, depending on the outcome of the comparison.

In a further embodiment, the locking means is arranged to disable access to the protected bus when an access-denying signal is received from the conditional checking means.

In another embodiment, the conditional checking means is arranged to send dummy data to the unprotected bus when said request for access is invalid.

When the conditional checking means determines that access to the protected bus needs to be disabled, the locking means can be arranged to block read access from and/or write access to the protected bus. Preferably, when an invalid request for read access is made, the conditional checking means will send dummy data to the unprotected bus.

In another embodiment, the conditional checking means is arranged to send a violation signal to the embedded processor for initiating a defence mechanism against malicious application codes.

Preferably, the conditional checking means can provide an indication to the unprotected bus that an invalid request was made. For example, a violation signal, such as an interrupt, an error or an abort, may be sent to the embedded processor for initiating a defence mechanism against possible malicious codes running on the processor.

These and other aspects of the present invention are apparent from and will be elucidated with reference to the embodiments described hereinafter.

In the drawings,

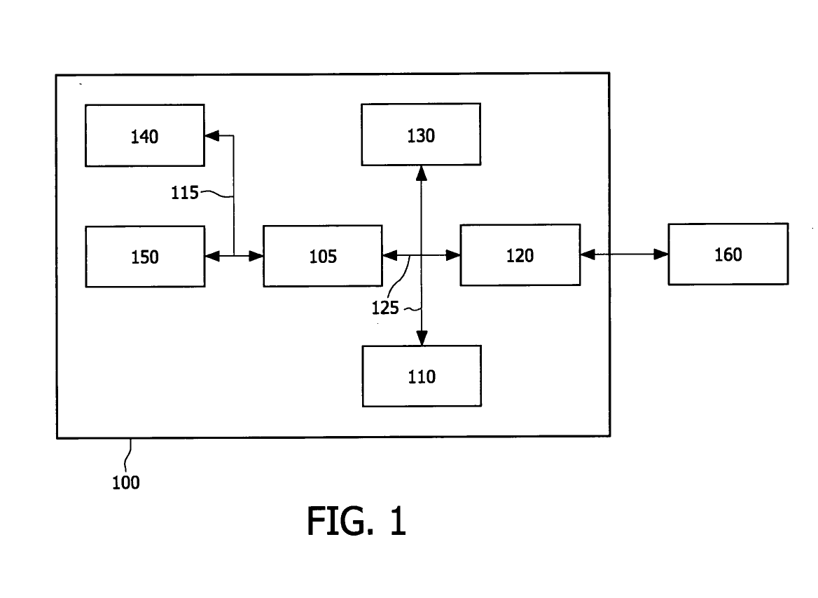

FIG. 1 schematically shows an overview of the architecture for the integrated circuit comprising the hardware firewall, and

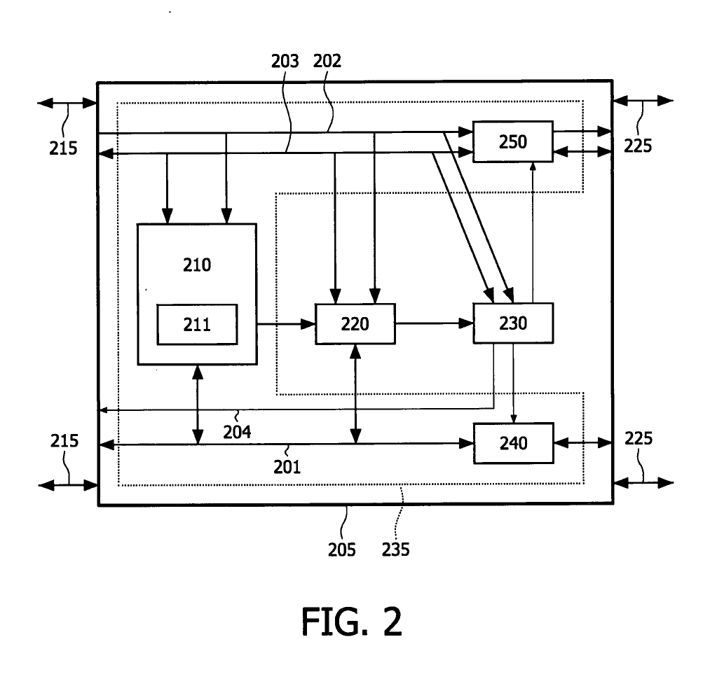

FIG. 2 schematically shows an overview of the architecture of the proposed firewall incorporated in the integrated circuit.

The drawings illustrate the embodiments of the invention and, together with the description, serve to explain the principles of the invention.

It should be noted that the above-mentioned embodiments illustrate rather than limit the invention and that those skilled in the art will be able to design alternative embodiments without departing from the scope of the appended claims. In the claims, any reference signs should not limit the scope of the claim. The invention can be implemented by means of hardware comprising several distinct elements.

Firewalls are used to provide protection against attacks to a system or device. Attacks may come from the software or application codes running on the system. The operating system software is not fully capable of preventing attacks from external codes running on the system. The invention therefore proposes a hardware firewall that can protect access to a protected bus and in particular to devices connected to the protected bus, in particular an embedded memory. The functional hardware element is embedded within a semiconductor device, for example, an integrated circuit. It is coupled to the embedded memory and to an embedded processor and/or preferably also to peripheral devices attached to the semiconductor device via the protected bus and via the unprotected bus.

FIG. 1 is a schematic architecture, which comprises a functional hardware element 105 to perform the role of a firewall. The semiconductor device 100 comprises a functional hardware element 105, hereinafter also referred to as hardware firewall. The hardware firewall 105 is coupled to an embedded processor 150 and preferably also to a bus master device 140 via an unprotected bus 115. In a similar way, the hardware firewall 105 is coupled to an embedded memory 110, for example, a RAM or ROM, and preferably also to an external memory interface 120 and system peripheral devices 130 via the protected bus 125. An external memory interface 120 preferably connects the hardware firewall 105 and an external memory 160, also via the protected bus 125.

The protection mechanism as defined by the hardware firewall 105 allows different levels, which can be defined in dependence upon the behavior of the application code that is requesting access to the protected devices.

In FIG. 1, it can be seen that the hardware firewall 105 is implemented between the embedded processor 150 and the embedded memory 110. The hardware firewall 105 can be used for protecting the protected bus 125, thereby protecting certain areas of the embedded memory 110 from being accessed by an application code running on the embedded processor 150. The hardware firewall 110 can also be programmed to define the access level for each area of the embedded memory 110 to be protected, and this will be discussed in detail with reference to FIG. 2. Different access levels can be defined for different areas of the embedded memory 110, or different other devices on the protected bus 125.

Various levels of protection can be defined by the hardware firewall 105 depending on the behavior of the application code that is requesting access to the devices, such as access to the protected bus 125, access to the embedded memory 110, etc. For example, the following levels of protection can be envisaged:

a—No Access is allowed at all: the hardware firewall 105 prevents any access to devices on the protected bus 125 locked during system start-up when the lock bit 211 (FIG. 2) is set. For example, during start-up, a system security check or critical parameter initializations need to be done, and access to these routines should be prevented after that;
b—Code fetch access only: some system-specific routines, for example, encryption or decryption routines that are used by the application code may be stored in a protected memory 110 but have to be available outside the protected area. Using code fetch, the routines can be located on the embedded processor 150;
c—Supervisor access: for example, to set a system clock or change certain system parameters in operation, the operating system may give supervisor access behind the hardware firewall 105 to devices on the unprotected bus 115 that can be trusted, such as routines with the operating system itself;
d—No Write Access: it may be important to prevent write access to data in, for example, the protected areas of the embedded memory 110 or peripheral registers. However, read access may still be required;
e—Full Access: complete access from the unprotected bus 115 can be available to certain content on the protected bus 125, for example, non-critical routines or data stored in the embedded memory 110.

The hardware firewall circuit 105 may be included in the embedded processor 150. However, this protection mechanism works only when the access is sent from the embedded processor 150 itself. A stand-alone hardware firewall 105 has the advantage that it can also prevent the protected bus 125 being accessed from other devices, such as a bus master 140. In addition, protection setting of the embedded memory 110 inside the embedded processor 150 can be disabled. A further use of this invention is in detecting whether unintentional access has been granted to faulty codes while debugging software that is running on the device. A further application of using the hardware firewall 105 is in restricting access to devices connected to the firewall via the protected bus 125 in a multi-bus environment depending on the access conditions defined.

FIG. 2 is a schematic representation of an embodiment of the hardware firewall 205. The hardware firewall 205 comprises a locking means 235, a configuration means 220 and a conditional checking means 230. The locking means 235 comprises lock registers 210, an access locking means 240 and a data locking means 250. The conditional checking means 230 is coupled to the lock registers 210 and the configuration means 220 via an address bus 202 and a control bus 203. A data bus 201 also couples the lock registers 210 and the configuration registers 220 to the data locking means 240 of the locking means 235. In addition, the address bus 202 is also coupled to the access locking means 250, which forms part of the locking means 235.

At least one lock bit 211 is used for globally locking at least part of the lock registers 210 before an application code is executed.

The hardware firewall 205 is attached to a protected bus 225, which connects to the embedded memory 110 and preferably also to the external memory interface 120 and peripheral devices 130. An unprotected bus 215 attached to the hardware firewall 205 connects to the embedded processor 150 and preferably also to a bus master 140.

The configuration means 220 comprises configuration registers that are used for storing access-related information and conditions for accessing the protected bus 225. The configuration registers defined in the configuration means 220 are preferably grouped in sets, wherein each set may define a protected area of the embedded memory 110, using, for example, a start address and an end address in the embedded memory 110.

A lock register 210 is preferably associated with at least one of the configuration registers 220. The lock registers 210 are arranged to selectively allow or deny access to the associated at least one of the configuration registers 220. For example, when the lock register 210 is not activated, the associated configuration registers 220 can either be read from or written to. When the lock register 210 is activated, the associated configuration registers 220 can only be read from.

At least one lock bit 211 associated with the lock register 210 can lock the lock registers 210 themselves. When the lock bit 211 is not activated, the lock registers 210 can be read from or written to without any limitations. However, when the lock bit 211 is activated, access to the lock register 210 is prevented. Thus, for lock registers 210 already activated, the protections already defined in the associated configuration registers 220 cannot be altered.

Similarly after setting the lock bit 211, access to devices on the protected bus 225 indicated by a locked configuration register 220 can be restricted. Only configuration registers 220 not currently associated with any lock register 210, or configuration registers 220 associated with an unlocked lock register 210 are then still accessible from the unprotected bus 215.

As a result, new protections can be defined after setting the lock bit 211, but when a protection is already defined in a configuration register 220, and a lock register 210 is associated with that configuration register 210 and is subsequently locked, the protection cannot be altered from the unprotected bus 215. Thus, protected devices or memory areas are safeguarded against unauthorized access from the protected bus 225.

The conditional checking means 230 continuously examines the unprotected bus 215 for access requests to the protected bus 225. The conditional checking means 230 also examines the access conditions that are stored in the locked configurations registers 220 that define the levels of protection for different devices on the protected bus 225. The conditional checking means 230 checks access requests on the unprotected bus 215 with the access conditions that are stored in the configuration means 220. If it is determined that the requested access should not be allowed, the conditional checking means 230 sends a signal to the access locking means 250 and the data locking means 240 to allow or deny read and/or write access depending on the resulting condition of the comparison. The conditional checking means 230 preferably provides an indicator to be used by the system in order to know when a violation of the access conditions has occurred in the system. When a violation of the access conditions has occurred, the conditional checking means 235 is arranged to send a violation signal 204 to the embedded processor to begin a defence mechanism, for example, an interrupt signal, an error signal or an abort signal.

The access locking means 250 continuously interacts with the conditional checking means 230. The access locking means 250 disables an access to the protected bus 225, requested from the unprotected bus 215, when the conditional checking means 230 sends a deny access signal to the access locking means 250.

In addition, the locking means comprises a data locking means 240 interacting with the conditional checking means 230. When there is an invalid access request from the unprotected bus 215, the conditional checking means 230 may instruct the data locking means 240 to send dummy data to the data lines of the unprotected bus 215.

The hardware firewall 205 has the advantage that the conditions are fully programmable and flexible, without compromising the security of the device. Another advantage is that the hardware firewall 205 allows applications contained in the external memory 160 to define certain customized areas of the protected bus 225 and the embedded memory 110 to be protected. A further advantage of the system is its use in the application of debugging software, wherein the hardware firewall 205 can protect the system against unintentional access by protecting the various devices in the system.

Although the invention has been elucidated with reference to the embodiments described above, it will be evident that other embodiments may be alternatively used to achieve the same object. The scope of the invention is therefore not limited to the embodiments described above but can be applied to other devices as well.

It should further be noted that use of the verb “comprise” and its conjugations in this specification, including the claims, is understood to specify the presence of stated features, integers, steps or components, but does not exclude the presence or addition of one or more other features, integers, steps, components or groups thereof. It should also be noted that use of the indefinite article “a” or “an” preceding an element in a claim does not exclude the presence of a plurality of such elements. Moreover, any reference sign does not limit the scope of the claims. The invention can be implemented by means of both hardware and software, and the same item of hardware may represent several “means”. Furthermore, the invention resides in each and every novel feature or combination of features.

The invention can be summarized as follows. A semiconductor device having circuitry comprising an embedded memory, an embedded processor for executing application codes, and a functional hardware element coupled with the embedded memory via a protected bus, and with the embedded processor via an unprotected bus, the hardware element being arranged to protect the protected bus, and including a locking means comprising a lock bit for globally locking at least part of the locking means before executing the application code.

1. A semiconductor device 100 having circuitry comprising an embedded memory 110, an embedded processor 150 for executing application codes, and a functional hardware element 105 coupled with the embedded memory 110 via a protected bus 125, and with the embedded processor 150 via an unprotected bus 115, the hardware element 105 being arranged to protect the protected bus 125, and including a locking means 235 comprising at least one lock bit 211 for globally locking at least part of the locking means 235 before executing the application code.

2. The device of claim 1, wherein the locking means 235 is arranged to protect areas of the embedded memory 110.

3. The device of claim 1, wherein the locking means 235 comprises lock registers 210, and at least one lock bit 211 is arranged to globally lock at least part of the lock registers 210.

4. The device of claim 1, wherein the functional hardware element 235 includes a configuration means 220 comprising configuration registers 220 for storing access for the protected bus 125, conditions and a lock register 210 which is associated with at least one of the configuration registers for selectively allowing or denying access to said at least one of the configuration registers 220.

5. The device of claim 4, wherein an activated lock register 210 indicates that the associated at least one of the configuration registers 220 is arranged to read only, and an inactivated lock register 210 indicates that the associated at least one of the configuration registers 220 is arranged to both read and write.

6. The device of claim 4, wherein the configuration registers 220 are arranged to define a protected embedded memory area 110.

7. The device of claim 1, wherein, after setting the lock bit 211, an unlocked part of the locking means 235 is still accessible from the unprotected bus 215.

8. The device of claim 4, wherein the functional hardware element 105 includes a conditional checking means 230 coupled with the configuration means 220 for comparing a request for access to the protected bus 225 with the access conditions stored in the configuration means 220, and providing a signal 204 to the locking means 235 for allowing or denying said request for access in dependence upon the result of said comparison.

9. The device of claim 8, wherein the locking means 235 is arranged to disable access to the protected bus 225 when an access-denying signal 204 is received from the conditional checking means 230.

10. The device of claim 8, wherein the conditional checking means 230 is arranged to send dummy data to the unprotected bus 215 when said request for access is invalid.

11. The device of claim 8, wherein the conditional checking means 230 is arranged to send a violation signal 204 to the embedded processor 150 for initiating a defence mechanism against malicious application codes.
